(19) United States
(12) Patent Application Publication
(10) Pub. No.: US 2011/0063877 A1
(43) Pub. Date: Mar. 17, 2011

(54) Synchronous rectifying circuit with primary-side swithching current detection for offline power converters

(76) Inventors: Ta-Yung Yang, Milpitas, CA (US); Ying-Chieh Su, Sijhih City (TW); Yen-Ting Chen, Xindian City (TW); Pei-Sheng Tsu, Shulin City (TW)

(21) Appl. No.: 12/585,472

(22) Filed: Sep. 16, 2009

(51) Int. Cl. H02M 3/335

(52) U.S. Cl. 363/21.06

(57) ABSTRACT

A synchronous rectifying circuit is provided for offline power converter. A pulse signal generator is utilized to generate a pulse signal in response to a switching current of the power transformer. An isolation device is coupled to the pulse signal generator for transferring the pulse signal through an isolation barrier of the power transformer. A synchronous rectifier includes a power switch and a control circuit. The power switch is coupled between the secondary side of the power transformer and the output of the power converter for the rectifying. The control circuit is operated to receive the pulse signal for turning on/off the power switch. The pulse signal is generated to turn on the power switch once the switching current is higher than a threshold.

### BACKGROUND OF THE INVENTION

1. Field of Invention

The present invention relates in general to a control circuit of power converter, and more particularly, to a synchronous rectifying control for offline power converter.

2. Description of Related Art

An offline power converter including a power transformer is used for providing isolation from AC line input to the output of the power converter for safety. In recent development, applying the synchronous rectifier in the secondary side of the power transformer is to reach higher efficiency conversion for power converters, such as “Control circuit associated with saturable inductor operated as synchronous rectifier forward power converter” by Yang, U.S. Pat. No. 7,173,835. However, the disadvantage of this prior art is an additional power consumptions caused by saturable inductors and/or current-sense devices. The saturable inductor and the current-sense device are needed to facilitate the synchronous rectifier operated in both continuous mode and discontinuous mode operations. The object of present invention is to provide a synchronous rectifying method and a synchronous rectifying circuit, which can achieve higher efficiency. Besides, no additional devices or complex circuits are required for both continuous mode and discontinuous mode operations.

### SUMMARY OF THE INVENTION

A synchronous rectifying circuit is developed to improve the efficiency of the offline power converter. It includes a pulse signal generator generating a pulse signal in response to a switching current of a power transformer and the rising edge/falling edge of a switching signal. The switching signal is utilized to switch the power transformer and regulate the offline power converter. An isolation device, such as a pulse transformer is coupled to the pulse signal generator to transfer the pulse signal from the primary side of the power transformer to the secondary side of the power transformer. A synchronous rectifier has a power switch and a control circuit. The power switch is coupled to the secondary side of the power transformer for the rectifying. The control circuit is operated to receive the pulse signal for turning on/off the power switch. The pulse signal is generated to turn on the power switch once the switching current is higher than a threshold. The pulse signal is a trig signal. The pulse width of the pulse signal is shorter than the pulse width of the switching signal.

### BRIEF DESCRIPTION OF ACCOMPANIED DRAWINGS

The accompanying drawings are included to provide a further understanding of the present invention, and are incorporated in and constitute a part of this specification. The drawings illustrate embodiments of the present invention and, together with the description, serve to explain the principles of the present invention. In the drawings,

FIG. 1 shows the circuit diagram of a preferred embodiment of an offline power converter with a synchronous rectifier according to present invention.

FIG. 2 is the schematic diagram of a preferred embodiment of the synchronous rectifier according to present invention.

FIG. 3 is the schematic diagram of a preferred embodiment of a control circuit of the synchronous rectifier according to present invention.

FIG. 4 is the schematic diagram of a preferred embodiment of a first delay circuit according to present invention.

FIG. 5 is a block schematic of a preferred embodiment of a pulse signal generator according to present invention.

FIG. 6 is the schematic diagram of a preferred embodiment of a signal generation circuit of the pulse signal generator according to present invention.

FIG. 7 is the schematic diagram of a preferred embodiment of a second delay circuit according to present invention.

FIG. 8 is the schematic diagram of a preferred embodiment of a threshold circuit of the signal generation circuit according to present invention.

FIGS. 9A and 9B show key waveforms of the synchronous rectifying circuit according to present invention.

### DETAILED DESCRIPTION OF PREFERRED EMBODIMENTS

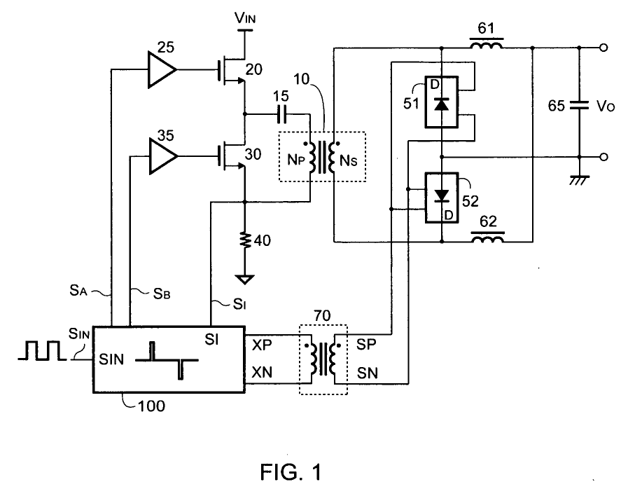

FIG. 1 shows a preferred offline power converter with a synchronous rectifier. The offline power converter includes a power transformer 10 having a primary winding Nₚ in the primary side and a secondary winding N_{S} in the secondary side. The primary side of the power transformer 10 has two power switches 20 and 30 for switching the power transformer 10. The power switch 20 receives an input voltage V_{IN} and is coupled to a first terminal of the primary winding Nₚ through a capacitor 15. The power switch 30 is coupled to the power switch 20 and a second terminal of the primary winding N_{P}. A switching voltage is produced across the secondary winding N_{S} in response to the switching of the power transformer 10. A switching current signal S_{I} is generated at a resistor 40 in accordance with a switching current of the power transformer 10. The switching current is a primary side current of the power transformer 10. The resistor 40 is coupled to the power switch 30 and the second terminal of the primary winding N_{P}.

A first synchronous rectifier 51 has a rectifying terminal D coupled to a first terminal of the secondary winding N_{S} for the rectifying. A ground terminal GND of the first synchronous rectifier 51 is connected to the ground of the power converter. A second synchronous rectifier 52 has a rectifying terminal D coupled to a second terminal of the secondary winding N_{S} for the rectifying. A ground terminal GND of the second synchronous rectifier 52 is also connected to the ground of the power converter. Inductors 61 and 62 are respectively connected from the first terminal and the second terminal of the secondary winding N_{S} to an output voltage V_{O} of the power converter. The output voltage V_{O} of the power converter is generated at an output capacitor 65. A first input terminal SP, a second input terminal SN of the first synchronous rectifier 51 and the second synchronous rectifier 52 are connected to the secondary side of an isolation device 70 to receive a pulse signal for turning on/off the synchronous rectifiers 51 and 52. The isolation device 70 can be a pulse transformer or capacitors.

A pulse signal generator 100 has a switching current terminal SI coupled to receive the switching current signal S_{I} for generating the pulse signal. The pulse signal generator 100 also has an input signal terminal SIN that is coupled to receive a switching signal S_{IN} for generating the pulse signal in response to the rising (leading) edge and the falling (trailing) edge of the switching signal S_{IN}. The switching signal S_{IN} is developed to switch the power transformer 10 and regulate the power converter. The pulse signal is produced on a first output terminal XP and a second output terminal XN of the pulse signal generator 100 in response to the switching current and the pulse width of the switching signal S_{IN}. The pulse signal is a differential signal. The polarity of the pulse signal determines turning on or off the synchronous rectifiers 51 and 52. In order to produce the pulse signal before the power transformer 10 is switched, the pulse signal generator 100 further generates drive signals S_{A} and S_{B} in response to the switching signal S_{IN}. The drive signals S_{A} and S_{B} are coupled to switch the power transformer 10 through drive-buffers 25, 35 and power switches 20, 30. A time delay is developed between the enable of the switching signal S_{IN} and the enable of the drive signals S_{A} and S_{B}.

The first output terminal XP and the second output terminal XN of the pulse signal generator 100 are coupled to the primary side of the isolation device 70 to transfer the pulse signal from the primary side of the power transformer 10 to the secondary side of the power transformer 10 through an isolation barrier of the power transformer 10. The pulse width of the pulse signal is shorter than the pulse width of the switching signal S_{IN}. The pulse signal is a trig signal that includes high frequency elements. Therefore, only a small pulse transformer is required, which saves the space of the PCB and saves the cost of the power converter. The pulse signal is generated to turn on the power switches of the synchronous rectifiers 51 and 52 once the switching current is higher than a threshold. When the power converter is operated in light load, the switching current signal S_{I} is lower than a threshold signal V_{T} shown in FIG. 8. The pulse signal generator 100 will only produce the pulse signal to turn off the synchronous rectifiers 51 and 52.

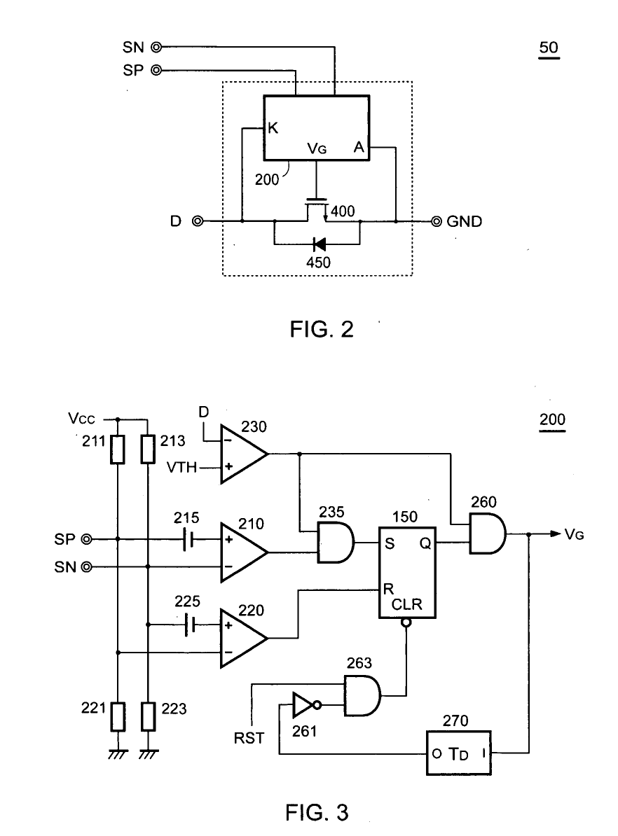

FIG. 2 is the schematic diagram of a synchronous rectifier 50. It represents the circuit of synchronous rectifiers 51 and 52. The synchronous rectifier 50 includes a power switch 400, a diode 450 and a control circuit 200. The diode 450 is connected to the power switch 400 in parallel. The power switch 400 is connected between a rectifying terminal D and a ground terminal GND for the rectifying. The rectifying terminal D is coupled to the secondary side of the power transformer 10. The ground terminal GND is coupled to the output of the power converter. The control circuit 200 is coupled to receive the pulse signal via a first input terminal SP and a second input terminal SN to generate a gate-drive signal V_{G} for turning on/off the power switch 400. The polarity of the pulse signal determines for turning on/off the power switch 400.

FIG. 3 shows the circuit diagram of the control circuit 200 of the synchronous rectifier 50 according to present invention. Resistors 211 and 221 are connected in serial for providing a bias termination for the first input terminal SP. Resistors 213 and 223 are connected in serial for providing another bias termination for the second input terminal SN. The resistors 211 and 213 are further coupled to a first supply voltage V_{CC}. The resistors 221 and 223 are further coupled to the ground. The first input terminal SP is coupled to a positive input of a first comparator 210 and a negative input of a second comparator 220. The second input terminal SN is coupled to a positive input of the second comparator 220 and a negative input of the first comparator 210. Comparators 210 and 220 have offset voltages 215 and 225 at the positive input respectively, which produces hysteresis.

A third comparator 230 having a threshold VTH connects to its positive input. A negative input of the third comparator 230 is coupled to the rectifying terminal D. The outputs of the comparators 210 and 230 are coupled to a set-input S of a SR flip-flop 250 through an AND gate 235 to set the SR flip-flop 250. A reset-input R of the SR flip-flop 250 is controlled by the output of the second comparator 220 to reset the SR flip-flop 250. An output Q of the SR flip-flop 250 and the output of the third comparator 230 are connected to inputs of an AND gate 260. The gate-drive signal V_{G} is generated at an output of the AND gate 260 for controlling the on/off of the power switch 400 of the synchronous rectifier 50 shown in FIG. 2. The SR flip-flop 250 serves as a latch circuit and receives the pulse signal through the comparators 210 and 220 to set or reset the latch circuit for turning on/off the power switch 400.

The maximum on time of the gate-drive signal V_{G} is limited by a first delay circuit 270. The gate-drive signal V_{G} is connected to the first delay circuit 270. After a blanking time, the output of the first delay circuit 270 will be produced in response to the enable of the gate-drive signal V_{G}. It is connected to an input of an AND gate 263 via an inverter 261. Another input of the AND gate 263 is connected to a power-on reset signal RST. An output of the AND gate 263 is coupled to a clear-input CLR to clear (reset) the SR flip-flop 250. The maximum on time of the gate-drive signal V_{G} is thus limited by the delay time of the first delay circuit 270. The gate-drive signal V_{G} will turn off the power switch 400 of the synchronous rectifier 50 once the pulse signal is generated as,

V_{SN}−V_{SP}>V₂₂₅ (1)

The gate-drive signal V_{G} will turn on the power switch 400 when equations (2) and (3) are met,

V_{SP}−V_{SN}>V₂₁₅ (2)

V_{DET}<V_{TH} (3)

where V_{SP} is the voltage of the first input terminal SP; V_{SN} is the voltage of the second input terminal SN. V_{DET} is the voltage of the rectifying terminal D. V_{TH} is the voltage of the threshold VTH; V₂₁₅ is the value of the offset voltage 215; V₂₂₅ is the value of the offset voltage 225.

The voltage of the rectifying terminal D will be lower than the voltage V_{TH} of the threshold VTH once the diode 450 of the synchronous rectifier 50 shown in FIG. 2 is conducted. It shows the power switch 400 can only be turned on after the diode 450 is turned on.

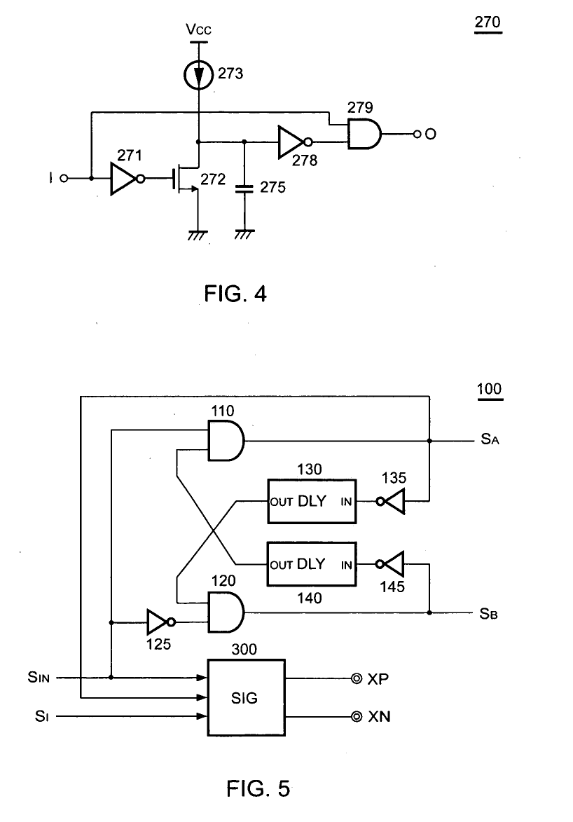

FIG. 4 is the circuit diagram of the first delay circuit 270 of the control circuit 200. A current source 273 is connected to the first supply voltage V_{CC} and is used to charge a capacitor 275. A transistor 272 is connected to the capacitor 275 and the ground to discharge the capacitor 275. An input signal I is coupled to control the transistor 272 through an inverter 271. The input signal I is further connected to an input of an AND gate 279. Another input of the AND gate 279 is coupled to the capacitor 275 via an inverter 278. Once the input signal I is enabled, an output of the AND gate 279 will generate an output signal O after the delay time. The delay time is determined by the current of the current source 273 and the capacitance of the capacitor 275. The input signal I can be the gate-drive signal V_{G} of the control circuit 200.

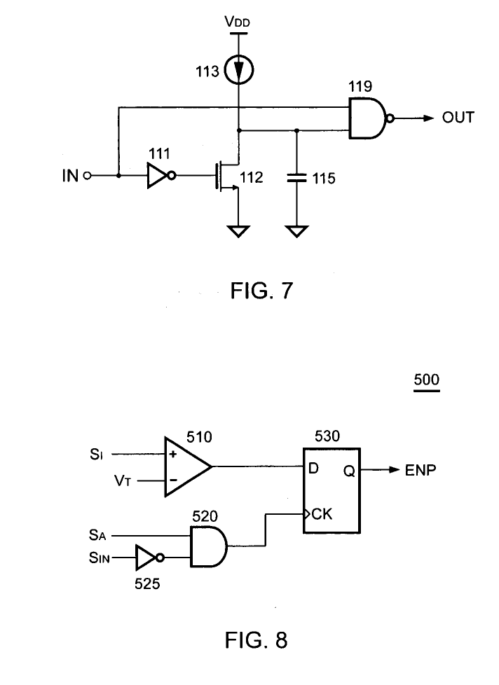

FIG. 5 is the block schematic of the pulse signal generator 100. The drive signals S_{A} and S_{B} are generated in response to the switching signal S_{IN}. The switching signal S_{IN} is connected to the input of an exclusive circuit. The exclusive circuit comprises AND gates 110, 120, delay circuits 130, 140 and inverters 125, 135, 145. The output of the exclusive circuit generates the drive signals S_{A} and S_{B}. The switching signal S_{IN} is coupled to an input of the AND gate 110. The switching signal S_{IN} is further coupled to an input of the AND gate 120 through the inverter 125. The outputs of the AND gates 110 and 120 generate the drive signals S_{A} and S_{B} respectively. The drive signal S_{A} is coupled to an input IN of the delay circuit 130 through the inverter 135. An output OUT of the delay circuit 130 is coupled to another input of the AND gate 120. The drive signal S_{B} is coupled to an input IN of the delay circuit 140 through the inverter 145. An output OUT of the delay circuit 140 is coupled to another input of the AND gate 110. A time delay is thus developed between the drive signals S_{A} and S_{B}. The circuits of the delay circuits 130 and 140 are shown in FIG. 7. The switching signal S_{IN}, the switching current signal S_{I} and the drive signal S_{A} are coupled to a signal generation circuit 300 to generate the pulse signal on the first output terminal XP and the second output terminal XN.

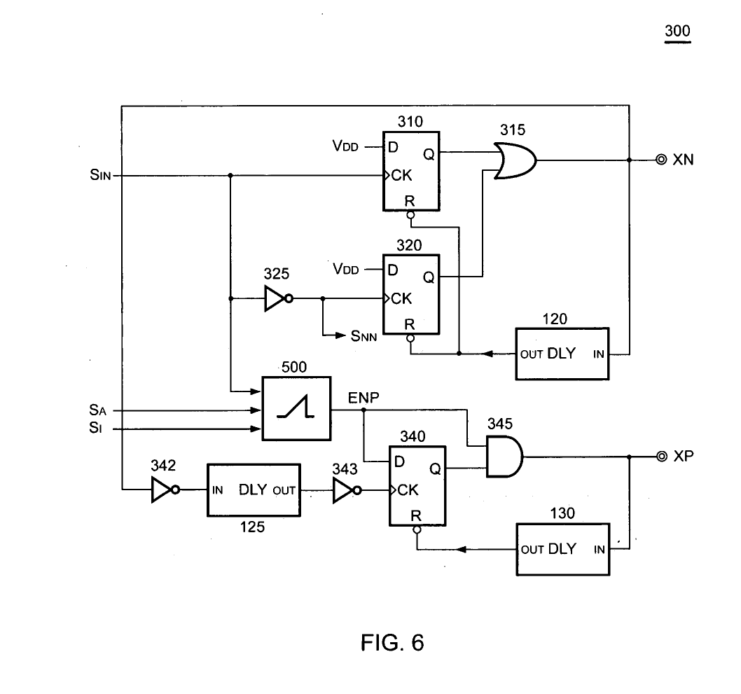

FIG. 6 is the schematic diagram of a preferred embodiment of the signal generation circuit 300 of the pulse signal generator 100. A D-input of a flip-flop 310 receives a second supply voltage V_{DD}. A clock-input CK of the flip-flop 310 is coupled to receive the switching signal S_{IN} and generates a first signal at an output Q of the flip-flop 310 connected to a first-input of an OR gate 315. The switching signal S_{IN} further generates a signal S_{NN} through an inverter 325. The signal S_{NN} is connected to drive a clock-input CK of a flip-flop 320. A D-input of the flip-flop 320 receives the second supply voltage V_{DD}. The flip-flop 320 outputs a second signal at an output Q connected to a second-input of the OR gate 315. The OR gate 315 is utilized to generate a negative-pulse signal at the second output terminal XN for turning off the synchronous rectifier 50 shown in FIG. 2. The negative-pulse signal is coupled to reset-inputs R of the flip-flops 310 and 320 to reset the flip-flops 310 and 320 through a delay circuit 120. An input IN of the delay circuit 120 is coupled to the second output terminal XN to receive the negative-pulse signal. An output OUT of the delay circuit 120 is coupled to the reset-inputs R of the flip-flops 310 and 320 to reset the flip-flops 310 and 320. The delay time of the delay circuit 120 determines the pulse width of the negative-pulse signal.

A threshold circuit 500 is coupled to receive the switching signal S_{IN}, the switching current signal S_{I} and the drive signal S_{A} for generating an enable signal ENP. The enable signal ENP is coupled to a D-input of a flip-flop 340 and an input of an AND gate 345. Through an inverter 343, a delay circuit 125, another inverter 342 and a clock-input CK of the flip-flop 340 is coupled to the second output terminal XN to receive the negative-pulse signal. An output Q of the flip-flop 340 is connected to another input of the AND gate 345. The AND gate 345 is utilized to generate a positive-pulse signal at the first output terminal XP. The positive-pulse signal is coupled to a reset-input R of the flip-flop 340 to reset the flip-flop 340 via a delay circuit 130. An input IN of the delay circuit 130 is coupled to the first output terminal XP to receive the positive-pulse signal. An output OUT of the delay circuit 130 is coupled to the reset-input R of the flip-flop 340 to reset the flip-flop 340. The delay time of the delay circuit 130 determines the pulse width of the positive-pulse signal. The pulse signal is therefore developed by the positive-pulse signal and the negative-pulse signal on the first output terminal XP and the second output terminal XN. The circuit schematic of the delay circuits 120, 125 and 130 are shown in FIG. 7.

FIG. 7 show the circuit schematic of a second delay circuit. A current source 113 is connected to the second supply voltage V_{DD} and is used to charge a capacitor 115. A transistor 112 is connected to the capacitor 115 and the ground to discharge the capacitor 115. The input signal is coupled to control the transistor 112 through an inverter 111. The input signal is further connected to an input of an NAND gate 119. Another input of the NAND gate 119 is coupled to the capacitor 115. An output of the NAND gate 119 is the output of the delay circuit. When the input signal is a logic-low, the capacitor 115 is discharged and the output of the NAND gate 119 is the logic-high. When the input signal is changed to the logic-high, the current source 113 will start to charge the capacitor 115. The NAND gate 119 will output a logic-low once the voltage of the capacitor 115 is higher than the input threshold of the NAND gate 119. The current of the current source 113 and the capacitance of the capacitor 115 determine the delay time T_{P} of the delay circuit. The delay time T_{P} is started from the logic-high of the input signal to the logic-low of the output signal of the delay circuit.

FIG. 8 is the schematic diagram of a preferred embodiment of the threshold circuit 500 of the signal generation circuit 300 according to present invention. The switching current signal S_{I} is connected to an input of a comparator 510. Another input of the comparator 510 is connected to the threshold signal V_{T}. An output of the comparator 510 is connected to a D-input of a D flip-flop 530. The drive signal S_{A} is connected to an input of an AND gate 520. Another input of the AND gate 520 is coupled to the switching signal S_{IN} via an inverter 525. An output of the AND gate 520 is coupled to a clock-input CK of the D flip-flop 530. An output Q of the D flip-flop 530 generates the enable signal ENP. When the switching current signal S_{I} is higher than the threshold signal V_{T}, the enable signal ENP will be generated in response to the drive signal S_{A} and the switching signal S_{IN}.

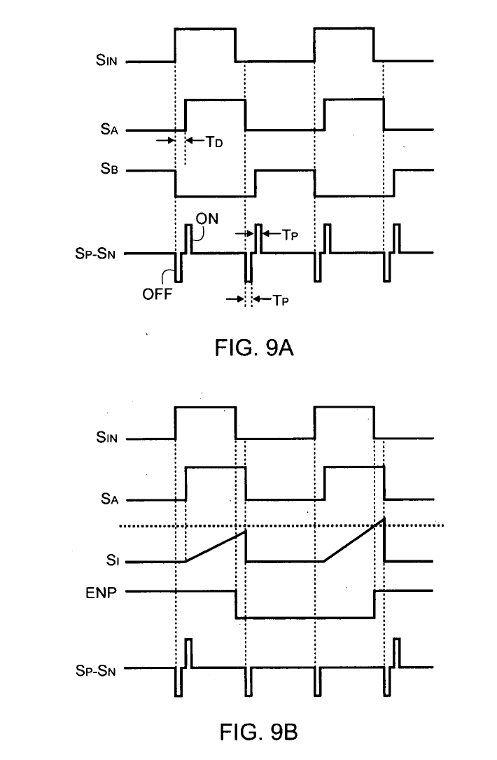

FIGS. 9A and 9B show key waveforms of the synchronous rectifying circuit. FIG. 9A shows a pulse signal S_{P}-S_{N} (negative-pulse signal) is generated in response to the leading edge and the trailing edge of the switching signal S_{IN} to turn off the power switch 400 to disable the synchronous rectifier 50 (shown in FIG. 2). Following the end of the negative pulse signal, a pulse signal S_{P}-S_{N} (positive-pulse signal) is generated to turn on the power switch 400 to enable the synchronous rectifier 50 if the diode 450 (shown in FIG. 2) of the synchronous rectifier 50 is conducted. FIG. 9B shows the waveforms of the switching current signal S_{I} and the enable signal ENP. The pulse signal S_{P}-S_{N} (positive-pulse signal) can only be generated when the enable signal ENP is generated (the switching current is higher than the threshold). It means the synchronous rectifiers 51 and 52 will be disabled during the light load and no load conditions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A synchronous rectifying circuit for offline power converter with a power transformer, comprising:
a pulse signal generator generating a pulse signal in response to a switching current;
an isolation device coupled to the pulse signal generator for transferring the pulse signal from a primary side of the power transformer to a secondary side of the power transformer; and
a synchronous rectifier having a power switch, a diode and a control circuit, the power switch coupled to the secondary side of the power transformer for the rectifying, the control circuit operated to receive the pulse signal for turning on/off the power switch;
wherein the switching current is a primary side current of the power transformer, the diode is coupled to the power switch in parallel, the polarity of the pulse signal determines to turn on or turn off the power switch.

2. The synchronous rectifying circuit as claimed in claim 1, wherein the pulse signal is generated to turn on the power switch once the switching current is higher than a threshold.

3. The synchronous rectifying circuit as claimed in claim 1, wherein the pulse signal is generated in response to the rising edge and the falling edge of a switching signal, the switching signal is coupled to switch the power transformer.

4. The synchronous rectifying circuit as claimed in claim 1, wherein the power switch can be turned on by the pulse signal once the diode is conducted.

5. The synchronous rectifying circuit as claimed in claim 1, wherein the isolation device is a pulse transformer or capacitors.

6. The synchronous rectifying circuit as claimed in claim 1, wherein the pulse signal is a trig signal, the pulse width of the pulse signal is shorter than the pulse width of a switching signal.

7. The synchronous rectifying circuit as claimed in claim 1, wherein the pulse signal generator further generates a drive signal in response to a switching signal, the drive signal is coupled to switch the power transformer, a time delay is developed between the enable of the switching signal and the enable of the drive signal.

8. The synchronous rectifying circuit as claimed in claim 1, wherein the pulse signal generator comprises:
a switching current terminal coupled to receive a switching current signal representative to the switching current;
an input signal terminal coupled to receive a switching signal;
a first output terminal generating the pulse signal;
a second output terminal generating the pulse signal, the pulse signal being a differential signal;
wherein the pulse signal generator produces the pulse signal to control the power switch in accordance with the switching current and the pulse width of the switching signal, the polarity of the pulse signal determines the pulse signal is generated for turning on or off the power switch.

9. The synchronous rectifying circuit as claimed in claim 1, wherein the pulse signal generator comprises a signal generation circuit for generating the pulse signal in response to the switching current and a switching signal, the pulse signal includes a positive-pulse signal and a negative-pulse signal, the positive-pulse signal is utilized for turning on the power switch, the negative-pulse signal is utilized for turning off the power switch.

10. The synchronous rectifying circuit as claimed in claim 9, wherein the signal generation circuit comprises a threshold circuit to generate an enable signal for generating the positive-pulse signal once the switching current is higher than a threshold.

11. The synchronous rectifying circuit as claimed in claim 1, wherein the control circuit comprises a latch circuit coupled to receive the pulse signal for setting or resetting the latch circuit, the latch circuit is coupled to turn on/off the power switch.

12. A method for providing synchronous rectifying for offline power converter having a power transformer comprising:
generating a pulse signal in response to a switching current;
transferring the pulse signal from a primary side of the power transformer to a secondary side of the power transformer through an isolation barrier;
setting or resetting a latch circuit in response to the pulse signal;
turning on/off a power switch in accordance with the status of the latch circuit;
wherein the power switch is coupled to the secondary side of the power transformer for the rectifying, the switching current is a current of the power transformer.

13. The method for providing synchronous rectifying as claimed in claim 12, wherein the latch circuit can be enabled to turn on the power switch only when a diode is conducted, the diode is coupled to the power switch in parallel.

14. The method for providing synchronous rectifying as claimed in claim 12, further comprising:
generating the pulse signal in response to the leading edge and the trailing edge of a switching signal, the switching signal being used for switching the power transformer.

15. The method for providing synchronous rectifying as claimed in claim 12, wherein the step of transferring the pulse signal is performed by an isolation device, the isolation device is a pulse transformer or capacitors.

16. The method for providing synchronous rectifying as claimed in claim 12, wherein the pulse width of the pulse signal is shorter than the pulse width of a switching signal.

17. The method for providing synchronous rectifying as claimed in claim 12, wherein the pulse signal will be generated to turn on the power switch once the switch current is higher than a threshold.

18. The method for providing synchronous rectifying as claimed in claim 12, further comprising:
generating a drive signal to switch the power transformer in response to a switching signal, a time delay being developed between the enable of the switching signal and the enable of the drive signal.

19. The method for providing synchronous rectifying as claimed in claim 12, further comprising:
receiving a switching signal; and
generating the pulse signal to control the power switch in accordance with the switching current and the pulse width of the switching signal;
wherein the pulse signal is a differential signal, the polarity of the pulse signal determines the pulse signal is generated for setting or resetting the latch circuit for turning on/off the power switch.

20. The method for providing synchronous rectifying as claimed in claim 12, wherein the pulse signal includes a positive-pulse signal and a negative-pulse signal, the positive-pulse signal is utilized for turning on the power switch, the negative-pulse signal is utilized for turning off the power switch.

21. The method for providing synchronous rectifying as claimed in claim 20, further comprising:
generating an enable signal for generating the positive-pulse signal once the switching current being higher than a threshold.
